(19) United States
(12) Patent Application Publication
(10) Pub. No.: US 2016/0335367 A1
(43) Pub. Date: Nov. 17, 2016

(54) ENTITY DISAMBIGUATION USING MULTISOURCE LEARNING

(71) Applicant: Microsoft Technology Licensing, LLC, Redmond, WA (US)

(72) Inventors: Kuansan Wang, Bellevue, WA (US); Arnab Sinha, Issaquah, WA (US); Yang Song, Kirkland, WA (US)

(21) Appl. No.: 14/713,152

(22) Filed: May 15, 2015

(51) Int. Cl. G06F 17/30

(52) U.S. Cl. CPC G06F 17/30893; G06F 17/30864

(57) ABSTRACT

Web pages that are known to be associated with entities, such as authors, are selected. Documents or other publications that are linked to or referenced by each web page are determined. Based on the authors of each determined document, the authors associated with each web page, and other information such as institutions or venues identified in each document, the various authors associated with the web pages are conflated or disambiguated to determine which authors, while having the same or similar names, should be treated as separate entities, and which authors, while having different names, should be treated as the same entities. Once the entity names have been conflated and disambiguated, they can be linked to social networking data or grant data associated with entities.

### BACKGROUND

Entity data, such as information identifying authors, researchers, institutions, publications, journals, and conferences, is increasingly being incorporated into search engines. For example, a user may want to search for a particular researcher to determine publications authored by the researcher, or to determine the field of study associated with the researcher. Sources of such entity data may include publisher feeds, digital libraries, social networking sites, and other sources, for example.

However, while entity data is useful, data from any one source can be incomplete or ambiguous, making incorporating such data into search engines difficult. One problem is known as under-conflation where one entity or individual is incorrectly treated as multiple entities or individuals. For example, a researcher who changes affiliations from one entity (e.g., university or research institution) to another may be erroneously treated as different individuals. Another problem is known as over-conflation where different entities or individuals are treated as the same individual. For example, two researchers with similar names may be erroneously treated as the same individual.

### SUMMARY

Web pages that are known to be associated with entities, such as authors, are selected. Documents or other publications that are linked to, or referenced by, each web page are determined. Based on the authors of each determined document, the authors associated with each web page, and other information such as institutions or venues identified in each document, the various authors associated with the web pages are conflated or disambiguated to determine which authors, while having the same or similar names, should be treated as separate entities, and which authors, while having different affiliations, should be treated as the same entity. Once the entity names have been conflated and disambiguated, they can be linked to social networking data or grant data associated with entities.

In an implementation, a plurality of web pages is determined by a computing device. For each web page, a plurality of documents referenced by the web page is determined by the computing device. For each web page, an author associated with the web page is determined by the computing device. For each document, an author associated with the document is determined by the computing device. For each web page, a plurality of name variants for the author associated with the web page is determined using the determined authors associated with the documents referenced by the web page by the computing device. For each web page, the plurality of name variants for the author is associated with the determined author of the web page by the computing device.

In an implementation, identifiers of a plurality of web pages are received by a computing device. Each web page is associated with an author. For each web page, a plurality of documents referenced by the web page is determined by the computing device. Each document is associated with an author. For each web page, a plurality of name variants for the author associated with the web page is determined based on the authors associated with the documents referenced by the web page. For each document, information comprising one or more of a venue, field of study, or institution associated with the document is determined by the computing device. The determined information is associated with the author determined for the web page that referenced the document by the computing device. A graph is generated by the computing device. The graph includes the authors associated with the web pages, the plurality of name variants determined for each author associated with the web pages, and the determined information associated with each author associated with the web pages.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for performing entity disambiguation and conflation;

FIG. 2 is an illustration of an example entity search engine;

FIG. 3 is an illustration of a portion of graph based on one or more entities;

FIG. 4 is an operational flow of an implementation of a method for author conflation and disambiguation;

FIG. 5 is an operational flow of an implementation of a method for generating a graph based on authors associated with web pages;

FIG. 6 is an operational flow of an implementation of a method for entity conflation and disambiguation; and

FIG. 7 shows an exemplary computing environment in which example embodiments and aspects may be implemented.

### DETAILED DESCRIPTION

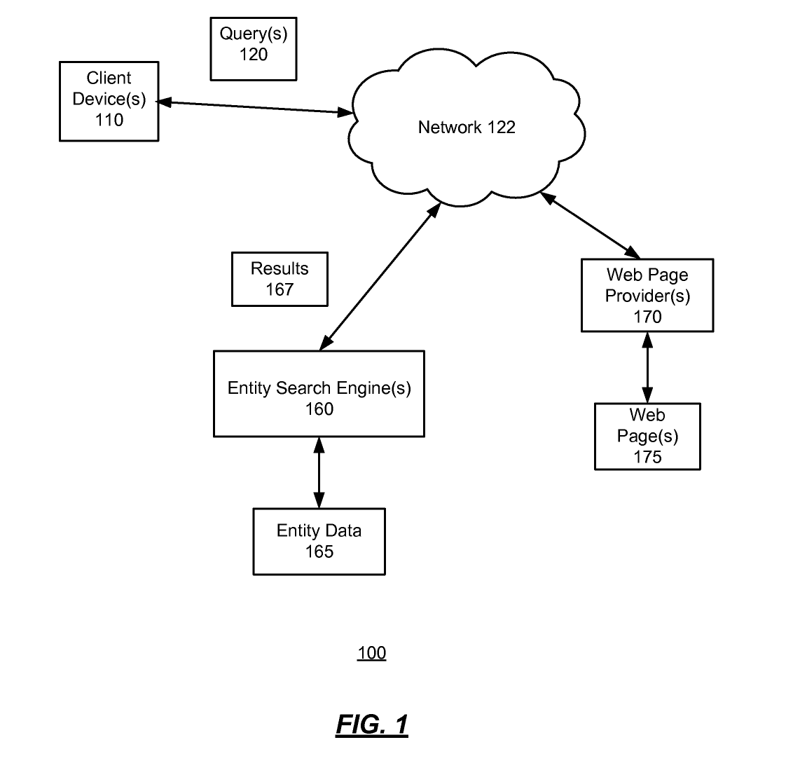

FIG. 1 is an illustration of an exemplary environment 100 for performing entity disambiguation and conflation. The environment 100 may include a client device 110, an entity search engine 160, and a web page provider 170 in communication through a network 122. The network 122 may be a variety of network types including the public switched telephone network (PSTN), a cellular telephone network, and a packet switched network (e.g., the Internet). Although only one client device 110, entity search engine 160, and web page provider 170 are shown in FIG. 1, there is no limit to the number of client devices 110, entity search engines 160, and web page providers 170 that may be supported.

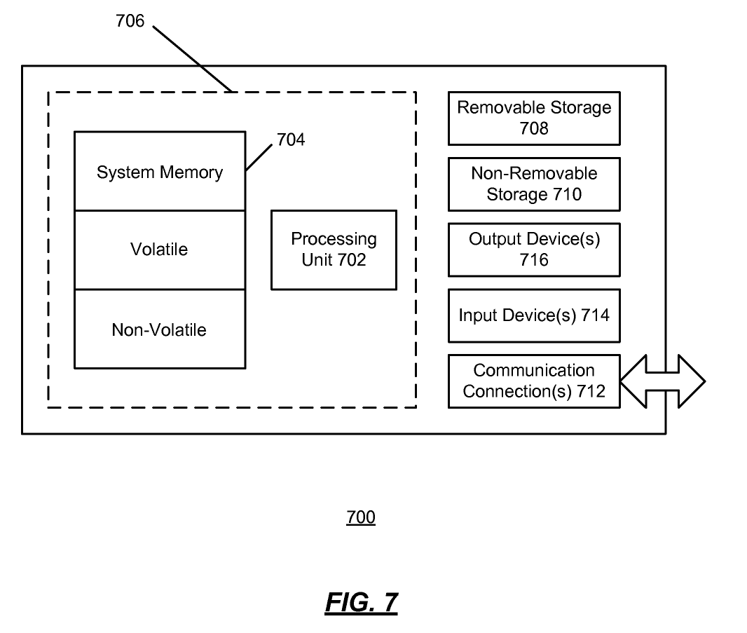

The client device 110, entity search engine 160, and web page provider 170 may be implemented together or separately using a general purpose computing device such as the computing device 700 described with respect to FIG. 7. The client device 110 may be a smart phone, video game console, laptop computer, set-top box, personal/digital video recorder, or any other type of computing device.

The entity search engine 160 may receive one or more query(s) 120 for entities from users of the client devices 110. Entities as used herein may include a variety of entity types including, but not limited to, people, places, and things. In one implementation, the entities may be academic entities and may include entities such as authors, researchers, and professors. The entities may further include institutions such as colleges, universities, corporations, and institutes. The entities may further include publications, such as journals and conference proceedings. The entities may further include documents such as publications, articles, patents or other research. The entities may also include venues such as conferences and workshops. The entities may further include subjects or fields of study such as computers, biology, etc. Other types of entities may be supported.

When the entity search engine 160 receives a query 120 from a client device 110, the entity search engine 160 may identify one or more entities that are responsive to the query 120 and may provide indicators of the responsive entities to the client device 110 as the results 167. The responsive entities may be determined by the entity search engine 160 from the entity data 165.

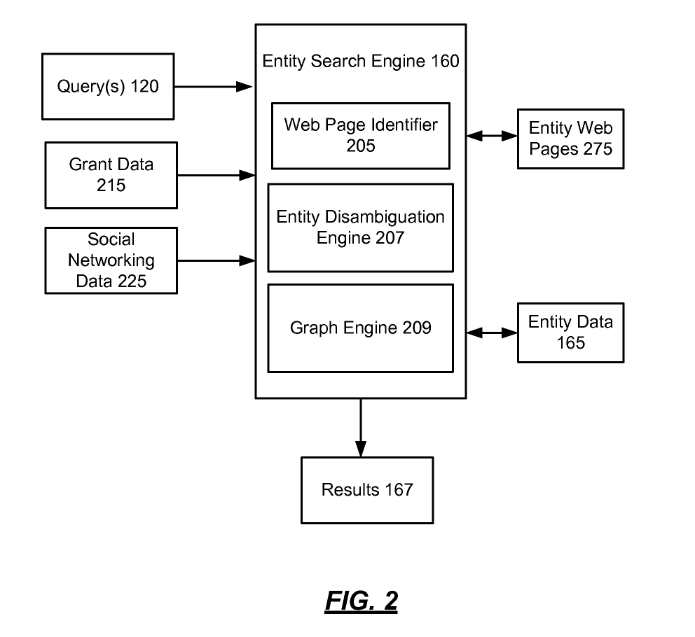

Some or all of the information included in the entity data 165 may have been collected by the entity search engine 160 from web pages 175 associated with the web providers 170, as well as other data sources or data feeds. For example, where the entities are academic entities, the web pages 175 may be web pages 175 associated with researchers or academics. As described further with respect to FIG. 2, the entity search engine 160 may extract information from the web pages 170 about the entities and may use the extracted data, along with data extracted from other sources such as social networks, and grant feeds, for example.

By performing entity disambiguation and conflation, the entity search engine 160 may improve the search experience of users when searching for entities. For example, when a user provides a query 120 to the entity search engine 160 for an entity such as “Richard P. Lee” at “The University of Wisconsin,” the entity search engine 160 may use the entity data 165 to determine that “Richard P. Lee” is the same author as “Rick Lee” who was previously associated with a different university, but is not the same author as “Richard M. Lee” who is also associated with The University of Wisconsin.” Accordingly, information from the entity data 165 associated with “Richard P. Lee” and “Rick Lee” may be presented to the user in the results 167.

FIG. 2 is an illustration of an example entity search engine 160. As shown, the entity search engine 160 includes one or more components including a web page identifier 205, an entity disambiguation engine 207, and a graph engine 209. More or fewer components may be supported. The entity search engine 160, and each of the one or more components, may be implemented together or separately using a computing device such as the computing device 700 illustrated with respect to FIG. 7.

As described above, one difficulty in providing information and other data about entities is the issue of entity over-conflation and entity under-conflation, especially with respect to academic entities. For example, researchers may change research institutions often, or may use different variations of their names at different times, making it difficult to determine if two similarly names researchers are the same or different entities. To better disambiguate entities and to avoid over-conflation and under-conflation, the entity search engine 160 may include both a web page identifier 205 and an entity disambiguation engine 207.

The web page identifier 205 may identify a set of web pages 175 that are associated with entities. Where the entities are academic entities, the web pages 175 may be web pages 175 that associated with researchers, authors, or other types of academics. Where the entities are actors, the web pages 175 may be web pages 175 that are associated with each actor. As may be appreciated, at least with respect to academic entities, each researcher or author typically maintains only one web page 175 that is about themselves. Thus, information contained on such a web page 175 associated with an author may be useful for determining the various other entities (i.e., publications, institutions, fields of study, venues, and events) that may be associated with the author, as well as any aliases or name variants that the author may be associated with.

In some implementations, the web page identifier 205 may identify the web pages that are associated with entities such as academics by initially selecting a seed set of web pages 175. The web pages 175 in the seed set may include web pages 175 that are known to be associated with entities as well as web pages 175 that are known to be not associated with entities. For example, where the entities are academic entities, the web page identifier 205 may receive a set of web pages 175 that are known to be associated with authors or researchers and a set of web pages 175 that are known to be not associated with authors or researchers. Any method or technique for selecting a seed set may be used.

The web page identifier 205 may use the seed set to determine characteristics of web pages 175 that are associated with entities. These characteristics can then be used to create one or more rules that can be used to identify web pages 175. For example, where the entities are academic entities the web page identifier 205 may determine prefixes, keywords, or other information that when associated with a web page 175 indicate that the web page 175 is associated with the desired entity.

The web page identifier 205 may use the determined rules and/or characteristics to identify web pages 175 that are associated with the desired entities. Depending on the implementation, once the web pages have been identified, the web page identifier 205 may filter out identified web pages 175 that are known to be not associated with the desired type of entity. The set of identified web pages may be stored as the entity web pages 275.

The entity disambiguation engine 207 may use the entity web pages 275 to identify entities, and to disambiguate or conflate entities that may share common characteristics or features. As an initial step, the entity disambiguation engine 207 may extract the likely name of each entity from the entity web pages 275. Typically, the name of an entity associated with a web page 175 is placed in a prominent position of a web page 175 such as the title or is highlighted using a specific font or color. In addition, with respect to academic entities, there is often a known template or format that is used to structure the web page 175 that may be used by the entity disambiguation engine 207 to extract the names from the entity web pages 275. Any method for extracting a name from a web page 175 or text document may be used.

Once the entity disambiguation engine 207 has determined a name for the entity associated with each of the entity web pages 275, the entity disambiguation 207 may perform what is referred to as entity conflation. Where the entities are authors and publications, the entity disambiguation engine 207 may locate references to one or more documents or publications that are identified by each entity web page 275. The documents or publications may include journal articles, presentations, or other research that is associated with the author. The document references may be determined by parsing the text of the entity web pages 275 looking for text or patterns that are typically associated with documents, for example.

Once the referenced documents are determined by the entity disambiguation engine 207, the entity disambiguation engine 207 may begin to perform entity conflation. For academic entities such as author names, entity disambiguation engine may determine the author names associated with each referenced document in an entity web page 275 and may determine which names are aliases or name variants for the author associated with the particular entity web page 275.

Depending on the implementation, the entity disambiguation engine 207 may perform author conflation by first generating a feature for each document referenced by an entity web page 275. The feature for a document may identify the document and each of the entity web pages 275 that references that document. The entity disambiguation engine 207 may then then determine aliases for each author associated with an entity web page 275 using the feature for each document. In some implementation, the entity disambiguation engine 207 may conflate the authors using a decision tree based algorithm that considers several factors in order of importance to determine which author names are unique, and which author names are just name variants of the same author. The considered factors may include how much of a match the names are, whether or not the names appear in the same entity web page 275, whether the author names appear with the same co-authors, and whether the author names appear affiliated with the same institutions. Other factors may be used.

Besides names, with respect to academic entities, the entity disambiguation engine 207 may perform entity conflation and disambiguation for other entities such as documents, venues, fields of study, institutions, and events. With respect to documents, the entity disambiguation engine may determine that referenced documents are the same documents if they have the same title, author(s), and date, but are associated with different aliases of conferences or journals and/or different author affiliations. For example, a same journal article may be found in the homepages of researchers associated with an abbreviation of the journal, and in the article summary page hosted by the journal publisher where it is associated with the full journal name and complete author affiliation information.

For entities such as venues, and events, the names of the venues and events extracted from the referenced documents may be cross checked against web pages 175 that are known to be associated with institutions or academic research. In addition, local information about academic journals and other institutions may be used to further disambiguate the venue and event entities.

Depending on the implementation, the entity disambiguation engine 207 may further consider social networking data 225 when conflating and/or disambiguating entities. In particular, the entity disambiguation engine 207 may use social networking data to determine which institutions are associated with a particular author, and to determine dates for each author institution association.

For example, users often post-employment history information on their social networking profile pages. This information may include information such as each institution that the user worked at along with the dates that they worked at the particular institution.

Accordingly, once an author has been conflated to determine a set of name variants used by the author, and one or more institutions associated with the author have been determined, the entity group disambiguation engine 207 may determine a social networking profile from the social networking data 225 that matches one or more of the name variants associated with the author and includes some or all of the same institutions that are associated with the author. Once a matching social networking profile is found in the social networking data 225, the various institutions, dates, and any other information can be associated with the author.

In addition, the entity disambiguation engine 207 may further consider grant data 215 when conflating or disambiguating entities. The grant data 215 may be received as a data feed from one or more institutions that award grants. The grant data 215 may identify the name of the authors that receive each grant, an amount of money associated with the grant, and a description of the work that may be associated with the graph. Because information provided by institutions regarding grants is often very detailed, the names and institutions associated with the graph data 215 may be used as additional information when conflating or disambiguating entities such as the names of authors or institutions.

Once the various entities have been conflated, the graph engine 209 may generate a graph representing the relationships between the determined entities as evidenced by one or more of the documents from the entity web pages 275, the grant data 215, and the social networking data 225. The generated graph may be stored as the entity data 165.

Depending on the implementation, graph may include a node for each entity and edges that represent relationships or associations between the nodes that the edges connect. Each node may only represent a single entity and where multiple name variants exist for a node, the node may be associated with each of the name variants. For example, where a node represents an author, the node may include identifiers of each of the name variants determined for the author by the entity disambiguation engine 207.

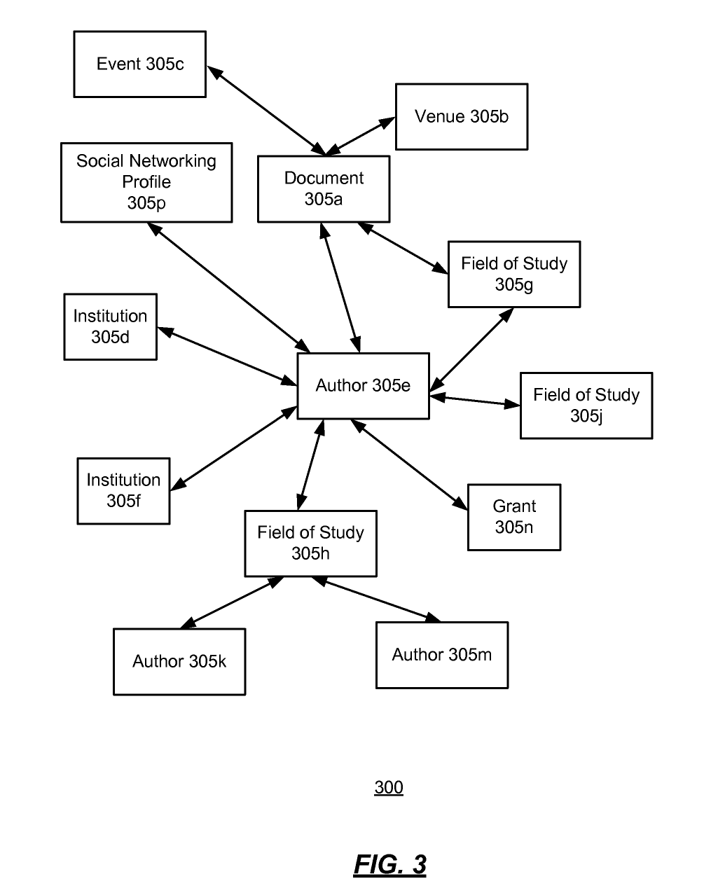

FIG. 3 is an illustration of a portion of graph 300 generated by the graph engine 209 based on one or more entities. The graph 300 includes a plurality of nodes 305 that each represent an entity. For example, the graph 300 shows nodes 305e, 305k, and 305m that represent author entities, shows nodes 305d and 305f that represent institution entities, shows nodes 305h, 305j, and 305g that represent field of study entities, shows the node 305a that represents a document entity, shows a node 305b that represents a venue entity, shows a node 305n that represents a grant entity, and shows a node 305c that represents an event entity. The graph 300 also shows a node 305p that represents a social networking profile associated with the author represented by the node 305e. While only thirteen nodes 305a-p are shown, there is no limit to the number of nodes that may be supported in the graph.

The edges or arrows between the nodes represent a relationship or association between the entities represented by the connected nodes. Depending on the implementation, the association may be based on the entries appearing together in a document referenced by an entity web page 275. Other information such as the grant data 215 and social networking data 225 may be used to determine the associations between entities.

When a query 120 is received by the entity search engine 160, the graph engine 209 may fulfill the query 120 based on the graph stored in the entity data 165. In some implementations, when a query 120 is received, the graph engine 209 may identify a node from the graph in the entity data 165 that matches or is a partial match of one or more terms of the query 120. The graph engine 209 may then generate results 167 based on the entity associated with the matching node. In some implementations, the results 167 may include information about the entity associated with the matching node, and information about some or all of the entities associated with nodes that are connected to the matching node in the graph.

For example, if a query 120 is received that matches the author node 305e, the graph engine 209 may generate results 167 that includes information about the author associated with the matching node 305e. The results 167 may further include information about the nodes that are connected to the matching node 305e (i.e., the nodes 305a, 305d, 305g, 305f, 305h, 305n, 305j, and 305p)

In addition, the results 167 may also include information from nodes that are not directly associated with the matching node, but that are within a predetermined distance from the matching node. For example, the node 305e has a distance of two from node 305c, 305b, 305k, and 305m. While these nodes are not directly associated with the matching node, they are likely to be related to the matching node. By providing information about these related nodes, a user can discover new entities that may be related to their query 120.

For example, the graph engine 209 may determine that the author entity represented by the node 305e matches a received query 120. In addition to information associated with the nodes directly connected to the node 305e, the graph engine 209 may include information about the authors associated with the nodes 305k and 305m in the results 167. Because the authors represented by the nodes 305k and 305m are associated with the same field of study (i.e., the node 305h) as the author represented by the matching node 305e, the user that generated the query 120 may also be interested in learning more about the authors represented by the nodes 305k and 305m.

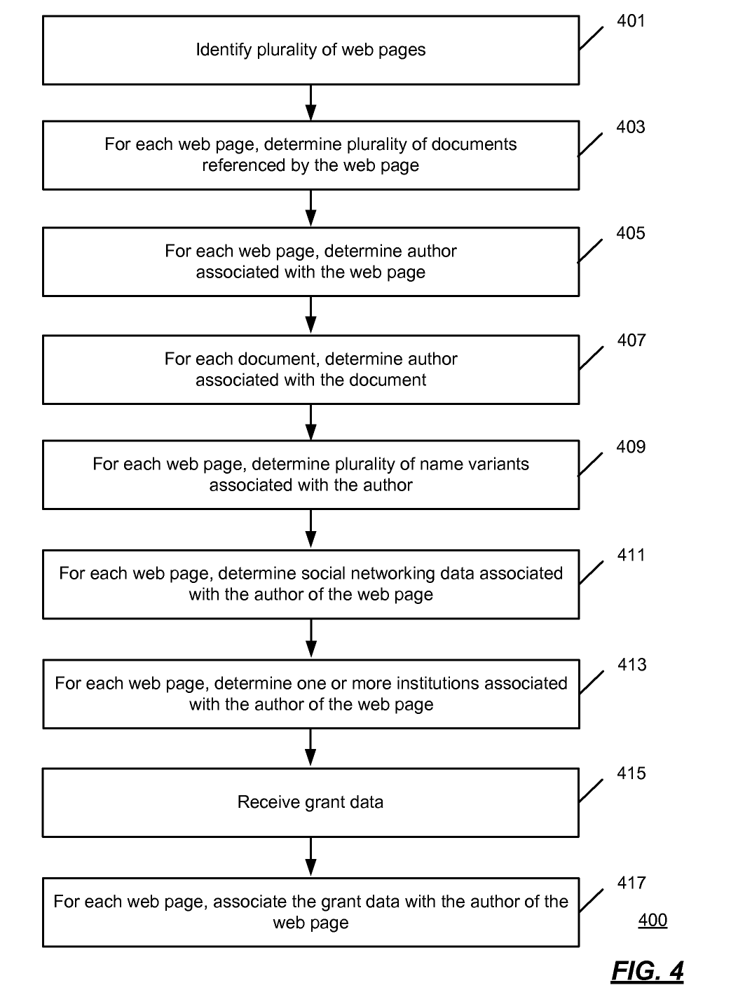

FIG. 4 is an operational flow of an implementation of a method 400 for author conflation and disambiguation. The method 400 may be implemented by the entity search engine 160.

At 401, a plurality of web pages are identified. The plurality of web pages may be the entity web pages 275 and may be web pages that are associated with academic entities, such as authors. The authors may include researchers, students, professors, and any other type of academic entities. Depending on the implementation, the entity web pages 275 may be identified by the web page identifier 205 of the entity search engine 160 based on prefixes and/or keywords typically associated with academic entities.

At 403, for each web page, a plurality of documents referenced by the web page is determined. The documents referenced by a web page may include academic research and/or other publications. The references to documents may be determined by the entity disambiguation engine 207 by parsing the web page for links or other references to documents, for example.

At 405, for each web page, an author associated with the web page is determined. The author may be the researcher or academic that is represented by the web page. Depending on the implementation, the author may be determined by the entity disambiguation engine 207. The entity disambiguation engine 207 may determine the author of the web page by parsing the web page for one or more names at locations of the web page where author names may typically be found, such as in a title section or near a particular heading. Any method for locating names in web pages may be used.

At 407, for each document, an author associated with the document is determined. The author may be determined by the entity disambiguation engine 207 of the entity search engine 160. The author (or authors) associated with the document may be determined by parsing the document similarly as described above for web pages, or may be based on metadata associated with each document.

At 409, for each web page, a plurality of name variants associated with the author of the web page is determined. The name variants associated with an author may include aliases or variations of the author's name that are used in the documents referenced by the web page associated with the author. Other information may also be used to determine the name variants of the author such as institutions, venues, fields of study, and other entities that may have been determined from the documents referenced by the web page. The name variants may be determined by the entity disambiguation engine 207 of the entity search engine 160.

At 411, social networking data associated with the author is determined. The social networking data 225 may be determined by the entity disambiguation engine 207 using the name variants associated with each author. Depending on the implementation, the social networking data 225 may include a profile associated with the author, for example.

At 413, for each web page, one or more institutions associated with the author of the web page is determined. The one or more institutions may be determined by the entity disambiguation engine 207 based on the social networking data 225. Depending on the implementation, the one or more institutions may include universities, companies, or other institutions associated with the author. In addition, each institution may be associated with a date or date range that indicates the period of time when the author was associated with the institution. The determined one or more institutions may be associated with the author of the web page.

At 415, grant data is received. The grant data 215 may be received by the entity disambiguation engine 207. The grant data 215 may identify researchers or authors associated with one or more grants. In addition, the grant data 215 may be associated with one or more institution such as universities that awarded each grant.

At 417, for each web page, the grant data is associated with the author of the web page. The grant data 215 may be associated with the authors based on the authors associated with each grant and the name variants associated with the authors of each web page. In addition, other information associated with the grant data 215 may be associated with the author associated with the web page such as the institutions associated with the grant data 215.

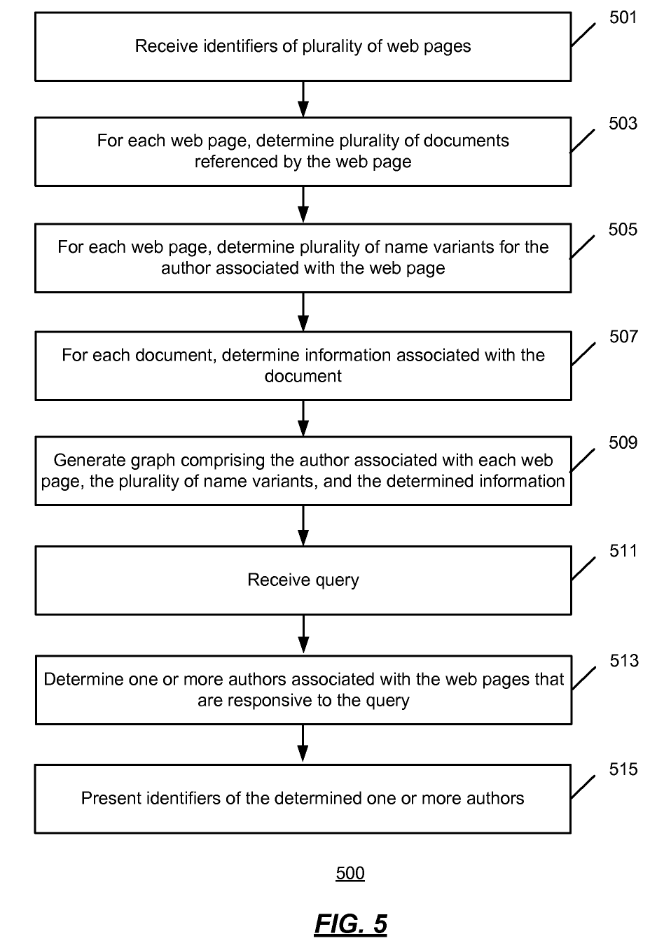

FIG. 5 is an operational flow of an implementation of a method 500 for generating a graph based on authors associated with web pages. The method 500 may be implemented by the entity search engine 160.

At 501, identifiers of a plurality of web pages are received. The identified web pages may be the entity web pages 275 and may be web pages that are known to be associated with academic entities such as authors.

At 503, for each web page, a plurality of documents referenced by the web page is determined. The plurality of documents may be determined by the entity disambiguation engine 207. The documents referenced by the web page may include one or more publications. Each document may be associated with one or more authors.

At 505, for each web page, a plurality of name variants for the author associated with the web page is determined. The plurality of name variants may be aliases or variations of the name used by the author of the web page and may be determined by the entity disambiguation engine 207 based on the names of the authors associated with the documents referenced by the web pages. The name variants may be stored by entity disambiguation engine 207 as the entity data 165.

At 507, for each document, information associated with the document is determined. The information may include identifiers of academic entities such as institutions, venues, events, and fields of study, and may be determined by the entity disambiguation engine 207. The information associated with each document may be associated with the author associated with the web page that referenced the document.

At 509, a graph is generated. The graph may be generated from the entity data 165 by the graph engine 209. Depending on the implementation, the graph may include a node for each author associated with a web page and a node for some or all of the other information associated with the author such as institutions, fields of study, events, venues, and the determined documents. The node for an author may also include each of the name variants determined for the author. The graph may also include edges that represent associations between the nodes. The association may be determined based on the information determined from the documents associated with each web page, as well as other information such as grant data 215 and social networking data 225.

At 511, a query is received. The query 120 may be received by the entity search engine 160 from a user of a client device 110. The query 120 may be a query for an academic entity such as an author and may include one or more terms that describe the particular academic entity.

At 513, one or more authors associated with the web pages that are responsive to the query are determined. The one or more authors may be determined by the graph engine 209 using the terms of the query 120 and the generated graph. In some implementations, the entity disambiguation engine 207 may determine the one or more authors by determining nodes of the graph that are associated with authors who name or determined name variants match, or partially match, some or all of the terms of the query 120.

At 515, identifiers of the determined one or more authors are provided. The identifiers of the one or more authors may be provided by the graph engine 209 to the client device 110 that originated the original query 120 as the results 167. Depending on the implementation, the results 167 may be a web page and may include information about the identified authors. The information may be from one or more nodes of the graph that share edges with the nodes corresponding to the determined one or more authors. These nodes may include information about one or more institutions, fields of study, events, documents, or venues that may be associated with the determined one or more authors.

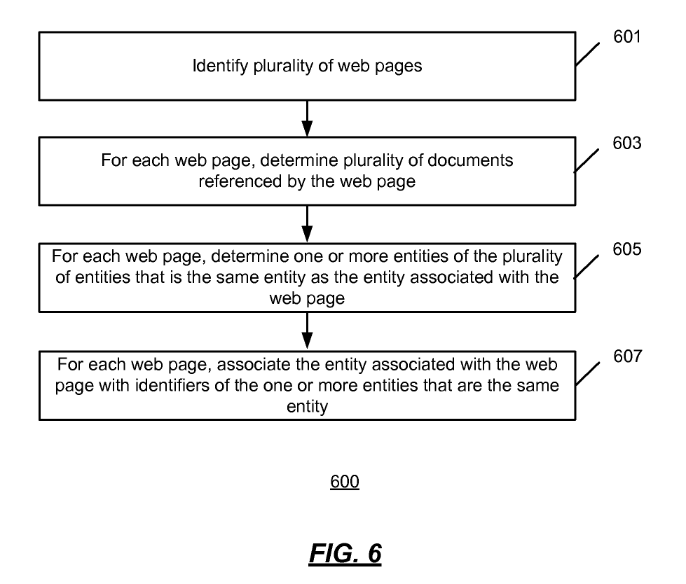

FIG. 6 is an operational flow of an implementation of a method 600 for conflating and disambiguating entities. The method 600 may be implemented by the entity search engine 160.

At 601, a plurality of web pages are identified. The plurality of web pages may be the entity web pages 275 and may be identified by the web page identifier 205 of the entity search engine 160. The plurality of web pages may be web pages 175 that are known to be associated with entities based on keywords or prefixes that occur in the text of the web pages 175 or in the URLs associated with the web pages 175. In some implementations, the entities may be authors and the entity web pages 275 are web pages 175 that are known to be associated with authors.

At 603, for each web page, a plurality of documents referenced by the web page is determined. The plurality of documents may be determined by the entity disambiguation engine 207. The plurality of documents references by a web page may include papers or publications associated with the author of the web page.

At 605, for each web page, one or more entities of the plurality of entities that are the same entity as the entity associated with the web page are determined. Determining the entities that are the same entity as another entity is known as entity conflation. Depending on the implementation, the entity disambiguation engine 207 may determine entities that are the same entity as the entity associated with a web page by determining name variants used for the entity associated with the web page in the documents referenced by the web page. Other information may be used such as grant data 215 and social networking data 225.

At 607, for each web page, the entity associated with the web page is associated with identifiers of the one or more entities that are the same entity. The entity associated with the web page may be associated with the identifiers in the entity data 165.

FIG. 7 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by the device 700 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In some implementations, a plurality of web pages is identified by a computing device. For each web page, a plurality of documents referenced by the web page is determined by the computing device. For each web page, an author associated with the web page is determined by the computing device. For each document, an author associated with the document is determined by the computing device. For each web page, a plurality of name variants for the author associated with the web page is determined using the determined authors associated with the documents referenced by the web page by the computing device. For each web page, the plurality of name variants determined for the author of the web page is associated with the author of the web page by the computing device.

Implementations may have some or all of the following features. For each document, the document may be associated with the determined author of the web page that referenced the document. For each document, information comprising one or more of a venue, field of study, event, or institution associated with the document may be determined, and the determined information may be associated with the author determined for the web page that referenced the document. A query comprising one or more terms may be received. Based on the one or more terms of the query and the plurality of name variants associated with each determined author of each web page, indicators of one or more of the authors associated with the web pages may be presented in response to the query along with the determined information associated with the indicated one or more authors. A graph may be generated using the determined information and the plurality of name variants associated with each determined author associated with each web page. For each web page, social networking data associated with the determined author of the web page may be determined based on the plurality of name variants associated with the author of the web page. For each web page, one or more institutions associated with the determined author of the web page and a date associated with each of the one or more institutions may be determined based on the social networking data associated with the determined author of the web page. For each web page, the determined one or more institutions and associated dates may be associated with the determined author of the web page. Identifying a plurality of web pages may include identifying web pages with URLs that begin with a prefix of a plurality of prefixes, or identifying web pages that include one or more keywords of a plurality of keywords. The documents may be academic publications. Grant data may be received. The grant data may be associated with an author. The grant data may be associated with a determined author of a web page of the plurality of web pages based on the author associated with the grant data and the plurality of name variants associated with the determined author of the web page.

In an implementation, identifiers of a plurality of web pages are received by a computing device. Each web page is associated with an author. For each web page, a plurality of documents referenced by the web page is determined by the computing device. Each document is associated with an author. For each web page, a plurality of name variants for the author associated with the web page is determined based on the authors associated with the documents referenced by the web page. For each document, information including one or more of a venue, field of study, or institution associated with the document is determined by the computing device. The determined information is determined with the author determined for the web page that referenced the document. A graph is generated by the computing device. The graph includes the authors associated with the web pages, the plurality of name variants determined for each author associated with the web pages, and the determined information associated with each author associated with the web pages.

Implementations may include some or all of the following features. A query comprising one or more terms maybe received. Based on the one or more terms of the query and the graph, one or more authors associated with the web pages that are responsive to the one or more terms of the query may be determined. Identifiers of the determined one or more authors may be provided in response to the query. For each web page, social networking data associated with the determined author of the web page may be determined based on the plurality of name variants associated with the author of the web page. The documents may be academic publications. Grant data may be received. The grant data may be associated with an author. The grant data may be associated with a determined author of a web page of the plurality of web pages based on the author associated with the grant data and the plurality of name variants associated with the determined author of the web page.

In an implementation, a system includes at least one computing device and an entity disambiguation engine. The entity disambiguation engine is configured to: identify a plurality of web pages, wherein each web page is associated with an entity of a plurality of entities; for each web page of the plurality of web pages, determine a plurality of documents referenced by the web page, wherein each web page is associated with an entity of the plurality of entities; for each web page of the plurality of web pages, determine one or more entities of the plurality of entities that is the same entity as the entity associated with the web page based on the entities associated with the plurality of documents referenced by the web page; and for each web page of the plurality of web pages, associate the entity associated with the web page with identifiers of the one or more entities that are the same entity.

Implementations may include some of all of the following features. The entities may include one or more of authors, fields of study, institutions, events, or venues. The entity disambiguation engine configured to identify a plurality of web pages may include the entity disambiguation engine configured to identify web pages with URLs that begin with a prefix of a plurality of prefixes, or identify web pages that include one or more keywords of a plurality of keywords. The entity disambiguation engine may be further configured to: receive grant data, wherein the grant data is associated with an entity of the plurality of entities; and associate the grant data with an entity associated with a web page of the plurality of web pages based on the entity associated with the grant data and the identified one or more entities associated with the entity associated with the web page. The entity disambiguation engine may be further configured to: determine social networking data associated with an entity associated with a web page of the plurality of web pages based on the identified one or more entities associated with the entity. The determined social networking data may include a profile associated with the entity.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
identifying a plurality of web pages by a computing device;
for each web page, determining a plurality of documents referenced by the web page by the computing device;
for each web page, determining an author associated with the web page by the computing device;
for each document, determining an author associated with the document by the computing device;
for each web page, determining a plurality of name variants for the author associated with the web page using the determined authors associated with the documents referenced by the web page by the computing device; and
for each web page, associating the plurality of name variants determined for the author of the web page with the author of the web page by the computing device.

2. The method of claim 1, further comprising for each document, associating the document with the determined author of the web page that referenced the document.

3. The method of claim 1, further comprising, for each document, determining information comprising one or more of a venue, field of study, event, or institution associated with the document, and associating the determined information with the author determined for the web page that referenced the document.

4. The method of claim 3, further comprising:
receiving a query comprising one or more terms; and
based on the one or more terms of the query and the plurality of name variants associated with each determined author of each web page, presenting indicators of one or more of the authors associated with the web pages in response to the query along with the determined information associated with the indicated one or more authors.

5. The method of claim 3, further comprising generating a graph using the determined information and the plurality of name variants associated with each determined author associated with each web page.

6. The method of claim 1, further comprising:
for each web page, determining social networking data associated with the determined author of the web page based on the plurality of name variants associated with the author of the web page;
for each web page, determining one or more institutions associated with the determined author of the web page and a date associated with each of the determined one or more institutions based on the social networking data associated with the determined author of the web page; and
for each web page, associating the determined one or more institutions and associated dates with the determined author of the web page.

7. The method of claim 1, wherein identifying a plurality of web pages comprises identifying web pages with URLs that begin with a prefix of a plurality of prefixes, or identifying web pages that include one or more keywords of a plurality of keywords.

8. The method of claim 1, wherein the documents are academic publications.

9. The method of claim 1, further comprising:
receiving grant data, wherein the grant data is associated with an author; and
associating the grant data with a determined author of a web page of the plurality of web pages based on the author associated with the grant data and the plurality of name variants associated with the determined author of the web page.

10. A method comprising:
receiving identifiers of a plurality of web pages by a computing device, wherein each web page is associated with an author;
for each web page, determining a plurality of documents referenced by the web page by the computing device, wherein each document is associated with an author;
for each web page, determining a plurality of name variants for the author associated with the web page based on the authors associated with the documents referenced by the web page;
for each document, determining information comprising one or more of a venue, field of study, or institution associated with the document by the computing device, and associating the determined information with the author determined for the web page that referenced the document; and
generating a graph by the computing device, the graph comprising the authors associated with the web pages, the plurality of name variants determined for each author associated with the web pages, and the determined information associated with each author associated with the web pages.

11. The method of claim 10, further comprising:
receiving a query comprising one or more terms;
based on the one or more terms of the query and the graph, determining one or more authors associated with the web pages that are responsive to the one or more terms of the query; and
presenting identifiers of the determined one or more authors in response to the query.

12. The method of claim 10, further comprising:
for each web page, determining social networking data associated with the determined author of the web page based on the plurality of name variants associated with the author of the web page;
for each web page, determining one or more institutions associated with the determined author of the web page and a date associated with each of the determined one or more institutions based on the social networking data associated with the determined author of the web page; and
for each web page, associating the determined one or more institutions and associated dates with the determined author of the web page.

13. The method of claim 10, wherein the document are academic publications.

14. The method of claim 10 further comprising:
receiving grant data, wherein the grant data is associated with an author; and
associating the grant data with a determined author of a web page of the plurality of web pages based on the author associated with the grant data and the plurality of name variants associated with the determined author of the web page.

15. A system comprising:
at least one computing device; and
an entity disambiguation engine configured to:
identify a plurality of web pages, wherein each web page is associated with an entity of a plurality of entities;
for each web page of the plurality of web pages, determine a plurality of documents referenced by the web page, wherein each web page is associated with an entity of the plurality of entities;
for each web page of the plurality of web pages, determine one or more entities of the plurality of entities that is the same entity as the entity associated with the web page based on the entities associated with the plurality of documents referenced by the web page; and
for each web page of the plurality of web pages, associate the entity associated with the web page with identifiers of the one or more entities that are the same entity.

16. The system of claim 15, wherein the entities comprise one or more of authors, fields of study, institutions, events, or venues.

17. The system of claim 15, wherein the entity disambiguation engine configured to identify a plurality of web pages comprises the entity disambiguation engine configured to identify web pages with URLs that begin with a prefix of a plurality of prefixes, or identify web pages that include one or more keywords of a plurality of keywords.

18. The system of claim 15, wherein the entity disambiguation engine is further configured to:
receive grant data, wherein the grant data is associated with an entity of the plurality of entities; and
associate the grant data with an entity associated with a web page of the plurality of web pages based on the entity associated with the grant data and the identified one or more entities associated with the entity associated with the web page.

19. The system of claim 15, wherein entity disambiguation engine is further configured to:
determine social networking data associated with an entity associated with a web page of the plurality of web pages based on the identified one or more entities associated with the entity.

20. The system of claim 19, wherein the determined social networking data comprises a profile associated with the entity.
